(19) United States
(12) Patent Application Publication
(10) Pub. No.: US 2005/0257694 A1
(43) Pub. Date: Nov. 24, 2005

(54) Method and apparatus for preparing a roast turkey analog from vegetarian ingredients

(76) Inventor: Margaret Afif, Palm Beach, FL (US)

Correspondence Address: JOHNSON & STAINBROOK LLP;Suite 203, 3558 Round Barn Blvd., Santa Rosa, CA, 95403, US

(21) Appl. No.: 11/134,190

(22) Filed: May 20, 2005

Related U.S. Application Data
(60) Provisional application No. 60/572,885, filed on May 20, 2004.

(51) Int. Cl. A23P 1/00

(52) U.S. Cl. 99/426

(57) ABSTRACT

The present invention provides a method and apparatus for preparing a roast turkey analog (replica) from vegetarian ingredients. The inventive apparatus includes a multi-piece roasted turkey-shaped mold suitable for filling with tofu or other vegetarian food, which can then be baked in an oven to produce a nourishing, festive main course for a vegetarian meal.

### CROSS REFERENCE TO RELATED APPLICATIONS

The present application claims the benefit of the filing date of U.S. Provisional Patent Application, Ser. No. 60/572,885, filed 20 May 2004.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to food and nutrition, and more particularly to an improved method and apparatus for preparing a vegetarian version of a traditional roast turkey.

### BACKGROUND INFORMATION AND DISCUSSION OF RELATED ART

Many people prefer to consume vegetarian meals. Unfortunately, some meals, and particularly festive meals such as Thanksgiving, are associated with main course or “centerpiece” meat products such as roast turkey. As a result, vegetarians who cannot or choose not to eat meat products may often feel “left out” of the festivities.

Food molds are well known and in widespread use. However, there are no known food molds that are suitable for creating an authentic-looking roast turkey shape food product, especially one made from vegetarian ingredients.

The foregoing information reflects the current state of the art of which the present inventor is aware. Reference to, and discussion of, this information is intended to aid in discharging Applicant's acknowledged duty of candor in disclosing information that may be relevant to the examination of claims to the present invention. However, it is respectfully submitted that none of the above information discloses, teaches, suggests, shows, or otherwise renders obvious, either singly or when considered in combination, the invention described and claimed herein.

### BRIEF SUMMARY OF THE INVENTION

The present invention provides a method and apparatus for preparing a roast turkey analog (replica) from vegetarian ingredients. The inventive apparatus includes a multi-piece roasted turkey-shaped mold suitable for filling with tofu or other vegetarian food, herbs, and spices, and which can then be baked in an oven to produce a nourishing, festive main course for a vegetarian meal.

It is therefore an object of the present invention to provide a new and improved method for preparing a vegetarian food product.

It is another object of the present invention to provide a new and improved oven roasted vegetarian meal suitable for serving in the place of roast turkey.

A further object or feature of the present invention is a new and improved food molding apparatus.

An even further object of the present invention is to provide a novel food mold to produce a roast turkey-shaped vegetarian food product suitable for serving on festive occasions such as Thanksgiving.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an exploded view of the components of an apparatus for preparing a roast turkey analog of this invention;

FIG. 2 is top plan view of the main body portion of the apparatus;

FIG. 3 is top plan view of the two side portions of the apparatus;

FIG. 4 is top plan view of the cavity mold portion of the apparatus; and

FIG. 5 is top plan view of the top plate portion of the apparatus.

### DETAILED DESCRIPTION OF THE INVENTION

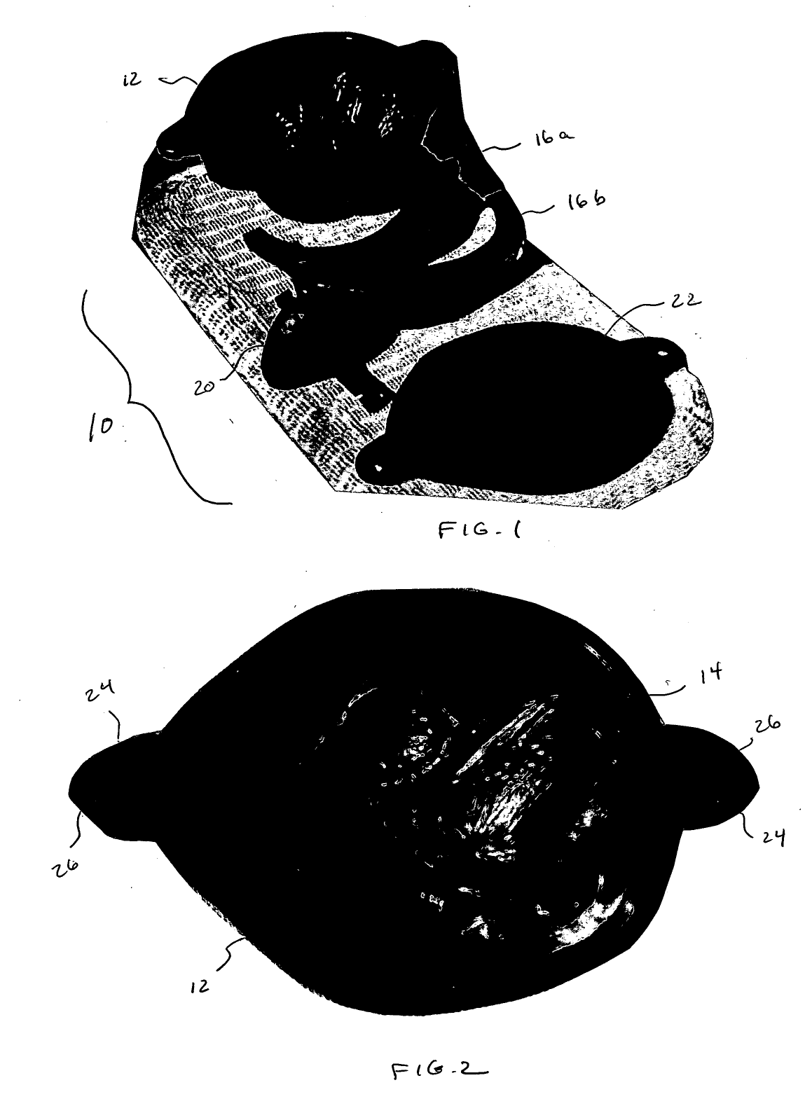

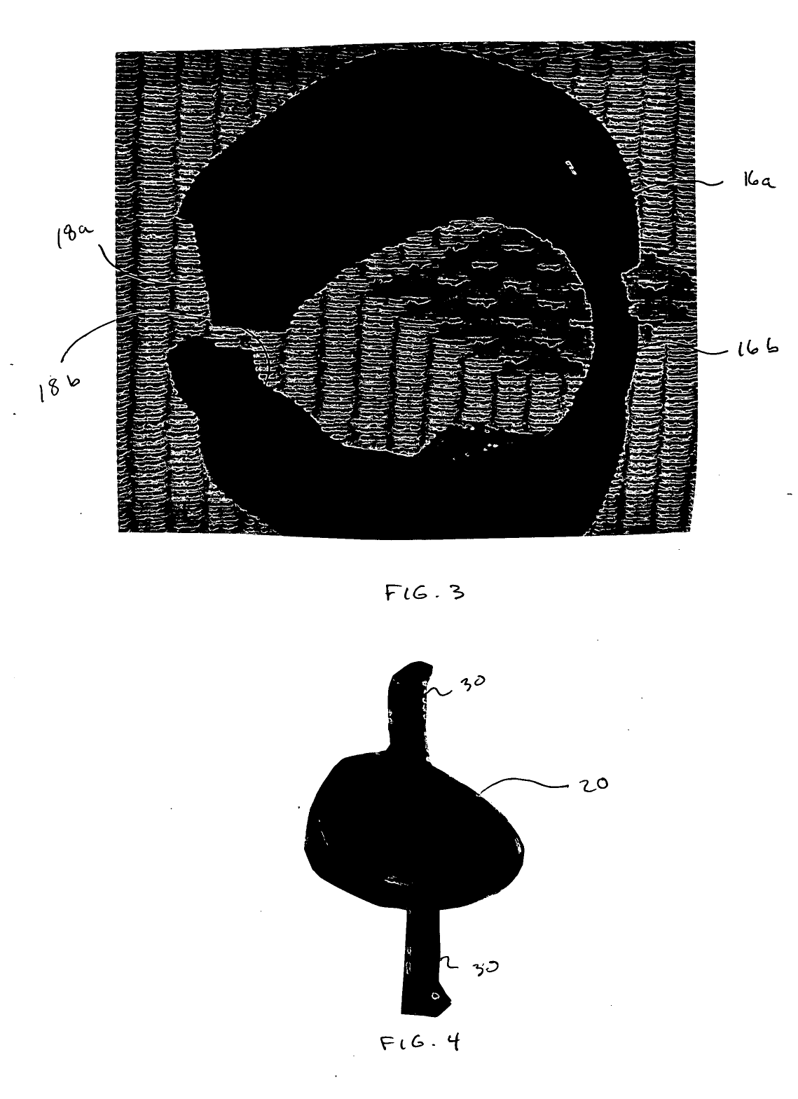

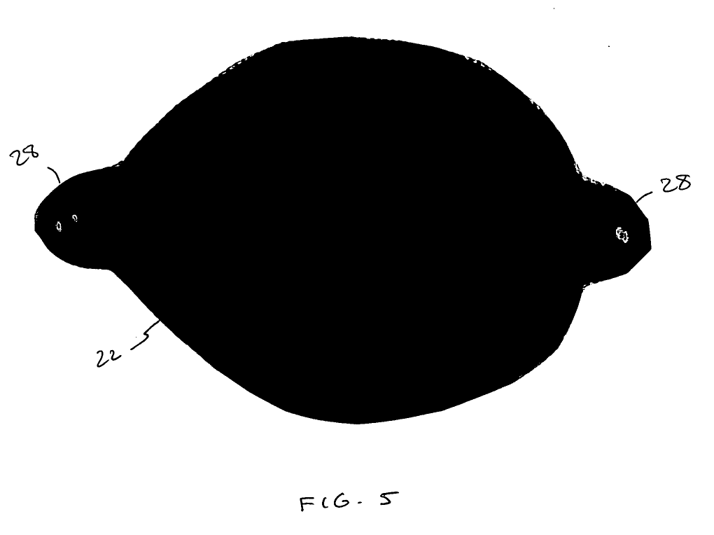

Referring to FIGS. 1 through 5, wherein like reference numerals refer to like components in the various views, there is illustrated therein a new and improved apparatus 10 for preparing a roast turkey-shaped food product from tofu or other vegetarian ingredients. The main body portion 12 of the mold forms the body of the roast turkey, and includes a lower cavity 14 in the form of a negative mold of a upper portion of a roast turkey shape (e.g., the breasts and drumsticks). The two side portions 16a, 16b have inside surfaces 18a, 18b that form the underside of the turkey shape (e.g., the thighs and undersides of the wings), and are placed into the main body portion 12 above the lower cavity 14. Alternatively, the side portions could be connected together as one piece. The cavity mold portion 20 forms a cavity within the mold for stuffing, if desired, although the apparatus may be used without this insert if no cavity for stuffing is needed. The top plate portion 22 forms the lid of the mold. One or all pieces preferably include a realistic roast-turkey skin texturing on its inside surface, to better replicate the look of a traditional roast turkey.

Main body portion 12 may include outwardly-extending tabs 24 bearing posts 26 adapted to engage complementary apertures 28 on top plate portion 22, to help fix the top plate to the main body during use.

Cavity mold portion 20 may include outwardly-extending arms 30 adapted to rest on the edges of main body portion 12.

The inventive method may include the following steps for preparing a roast turkey analog: Place the side portions 16a, 16b in the main body portion 12; coat the mold with oil; place the desired mixture in the mold; press the mixture into the mold to remove all air spaces; leave a cavity for the stuffing, if desired, by inserting cavity mold portion 20 to make the cavity (alternatively, fill the entire mold); place the top plate portion 22 on the mold; bake at 375 degrees F for 60 minutes; after baking, turn the mold over; remove the main body portion 12; remove both side portions 16a, 16b; and slide the finished turkey from the top plate portion 22.

A formula for soy turkey suitable for use in the inventive apparatus may include: 5 lbs. Tofu; 35 grams natural vegetarian chicken flavor; 35 grams Nutrient Supplement, Brewers yeast; 10 grams dried Seaweed (Agar-Agar); 5 grams dried sage powder; 3 grams dried turmeric powder. Place all ingredients in food processor, blend until completely smooth. Place mixture into the mold. The soy turkey is baked for 60 minutes at 375 degrees F. As a variation fill the mold cavity with the a stuffing formula and then bake.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. An apparatus for preparing a roast turkey-shaped food product from vegetarian ingredients, said apparatus comprising:
a main body portion to form the body of the roast turkey, said main body portion including a lower cavity in the form of a negative mold of a upper portion of a roast turkey shape;
at least one side portion having an inside surface that forms the underside of the turkey shape; and
a top plate portion to form the lid of the mold.

2. The apparatus for preparing a roast turkey-shaped food product of claim 1 wherein said side portion comprises a pair of side portions.

3. The apparatus for preparing a roast turkey-shaped food product of claim 1 wherein said main body portion includes roast-turkey skin texturing on its inside surface.

4. The apparatus for preparing a roast turkey-shaped food product of claim 1 wherein said side portion includes roast-turkey skin texturing on its inside surface.

5. The apparatus for preparing a roast turkey-shaped food product of claim 1 wherein said top plate portion includes roast-turkey skin texturing on its inside surface.

6. The apparatus for preparing a roast turkey-shaped food product of claim 1 further including a cavity mold portion to form a cavity within the apparatus for stuffing.

7. The apparatus for preparing a roast turkey-shaped food product of claim 1 wherein said main body portion includes outwardly-extending tabs bearing means to engage said top plate portion.

8. The apparatus for preparing a roast turkey-shaped food product of claim 1 wherein said cavity mold portion includes outwardly-extending arms adapted to rest on the edges of said main body portion.

9. A method for preparing a roast turkey-shaped food product, said method comprising the steps of:
providing a mold having a main body portion to form the body of the roast turkey, the main body portion including a lower cavity in the form of a negative mold of a upper portion of a roast turkey shape, a pair of side portions each having inside surfaces that form the underside of the turkey shape, and a top plate portion to form the lid of the mold;
placing both side portions in the main body portion;
coating the mold with oil;
placing the desired mixture in the mold;
pressing the mixture into the mold to remove all air spaces;
placing the top plate portion on the mold;
baking the mold and mixture;
turning the mold over;
removing the main body portion;
removing both side portions; and
sliding the finished turkey from the top plate portion.
